(19) United States
(12) Patent Application Publication
(10) Pub. No.: US 2005/0210682 A1
(43) Pub. Date: Sep. 29, 2005

(54) Blister knife

(76) Inventor: Henrik Bartholin, Rungsted (DK)

Correspondence Address: SUGHRUE MION, PLLC, 2100 PENNSYLVANIA AVENUE, N.W., SUITE 800, WASHINGTON, DC, 20037, US

(21) Appl. No.: 10/494,291

(22) PCT Filed: Nov. 5, 2002
(86) PCT No.: PCT/DK02/00745

§ 371 Date: May 3, 2004

(30) Foreign Application Priority Data
Nov. 6, 2001 (DK) PA 2001 01642

(51) Int. Cl. B26B 3/06

(52) U.S. Cl. 30/162; 83/293; 83/329

(57) ABSTRACT

A device for opening blister packs without annular depressions around the blisters serving as guidance trails is provided comprising a handle and a cutter having a suitable transverse dimension and form of cross section at the position of the intended cutting, making it suitable for cutting the foil of the type used in blister packs, and for opening any pack or container wrapped in a foil or any other cutable material or tape used for packaging as such. A preferred cutter is having cutter formed essentially as a rod and further provided with a point in order to facilitate penetration of foils. The device may be provided with means for protection of the cutter in order to avoid unintended cuts during storage and transport. The handle of the device may be shaped in order to facilitate the use by elderly and/or patients suffering from a rheumatic disease. The device is versatile and simple to use and may provide a relief of a long felt problem for nurses and other medical staffs, elder patients and in particular patients suffering from a rheumatic disease.

The present invention relates to a tool for opening of blister packs. In particular the invention relates to tool for opening blister packs for medicines.

### BACKGROUND FOR THE INVENTION

During the last decade blister packing has been increasingly more popular for packaging of medicine, creams, lotions etc, typically pills.

Blister packs typically consists of a sheet of a plastic material having a number of blisters each formed in order to receive a pill of a certain size. The open end of the blisters are closed after filling with a foil, typically a metal foil that has to be broken before the contained product can be released for use.

The user has to press the blister on the plastic side in order to break the metal foil by force and release the content.

Several advantages are connected to blister packing of pills. For example are the pills stable and protected from dirt, moist and to some extend against impacts. In addition it is possible to print e.g. the name of the pills on the blister pack, which facilitates the identification of the pills when removed from the primary packing.

The main problem by the use of blister packs is the force that has to be applied to the pack in order to release the pills. During a working day nurses and other medical staff may have to administer a large number of pills e.g. 300-600 pills per day, and as the number of pills that are supplied in blister packs has increased damages in hands and joints has been encountered among nurses and medical staff.

Elderly patients and in particular patients suffering from a rheumatoid disease are having troubles opening blister packs in order to release pills.

Further, as force has to be applied to blister packs in order to release the pills, these are always released with a certain momentum with the consequence that pills are easily dropped. This may further contribute to the discomfort encountered by these patients using medicines supplied in blister packs.

A number at approaches has been taken in order to address these disadvantages of blister packs.

In U.S. Pat. No. 5,088,603 a blister pack provided with a slit in order to ease the opening is disclosed. U.S. Pat. No. 5,673,793 discloses a blister pack provided with a frame connected to a pivotal lever, which can be actuated in order to open the blister, and U.S. Pat. No. 5,816,404 discloses a blister pack provided with an opening system comprising two upstanding spaced walls forming a slot that can be affected by e.g. a coin in order to turn the system, which opens the blister and releases the pill. Even though the above may be an improvement of opening the blister packs designed according to said documents the problem is not solved as such because the vast majority of medicaments are still supplied in blister packs without the described opening facilities.

An apparatus for opening blister packs is disclosed in U.S. Pat. No. 4,975,015 provided with a particular arranged knife in order to open blister packs. In use the blister pack is fixed in a drawer like part of the apparatus and moved towards a stationary knife, which cuts the blister and releases the content into a funnel, which guides it down to a collection area. Even thought this apparatus may be well suited to open large numbers of blister packs it represents a large apparatus that is not easily transported and can not be expected that ordinary patients have such an apparatus available at home.

In EP 0 629 554 A1 a device for pressing objects from blister packs is disclosed. In the device one side of the blister pack rests on a rib, while the blister to be empties rests on a boss. By pressing a tab the blister pack is forced down on the boss and the blister breaks and releases its content into a receiver section. Thus, the blister pack and the device have to be adapted for each other so that one device can only be used for one size of blister pack.

U.S. Pat. No. 5,833,071 disclose a child resistant blister pack comprising an annular depression in the blister pack around each blister covered with a lid that is sufficient resistant to prevent children to release tablets contained the blisters. In order to open these blister packs a sharp tool must be used to penetrate the lid in the annular depression and subsequently said tool should be run around the annular depression and thereby releasing the tablet contained in the blister in the annular depression. Thus the annular depression around each blister serves as a guidance trail for the tool. Even though this invention have been known for some years now the use of said system seems to have had little attention within the area as the major part of blister marketed at present do not have any guidance trails as required according to the provisions of U.S. Pat. No. 5,833,071.

Despite the above mentioned prior art there is still a need for a device for opening blister packs without guidance trails, which device is versatile, simple to use and may be operated by elderly patients, particular patients suffering from rheumatic diseases.

### SHORT DESCRIPTION OF THE INVENTION

The object of the invention is achieved by a device for opening blister packs without guidance trails comprising a handle and a cutter wherein the cutter is having a suitable transverse dimension and form of cross section at its position of the intended cutting, making it suitable to serve its purpose.

The invention is based on the surprising realisation that a cutter having such a transverse dimension and form of cross section at its position of intended cutting is able to cut or tear a foil of the type used in blister packs without guidance trails in any direction even though not guidance trails are provided to guide the cutting tools.

It has surprisingly been found that blister packs without guidance trails easily can be opened using a device according to the invention. In use the cutter is pressed through the foil covering the blister and is moved partially or complete essentially around the circumference of the blister whereby the blister is opened and the contained medicament is freed regardless is any particular means are provided in the blister packs in order to facilitate cutting of the foil covering the tablets, such as guidance trails. Thus in contrast to U.S. Pat. No. 5,833,071 the devise for cutting opening blister packs according to the invention may be use to open blister packs regardless if particular provisions such as guidance trails are provided in the blister packs.

In one preferred embodiment the cutter is provided with a point in order to ease the penetration of the foil covering the blister packs.

In another preferred embodiment the cutter is further provided with means for protection during storage and handling in order to avoid unintended cuts.

In still another preferred embodiment the handle is shaped as a shaft of a pen. In this embodiment e.g. nurses may keep the device in a pocket until the time and place where the medicament has to be administered to a patient, and thus the medicament can be contained in the protective blister until immediately before is it administered.

### DESCRIPTION OF THE DRAWING

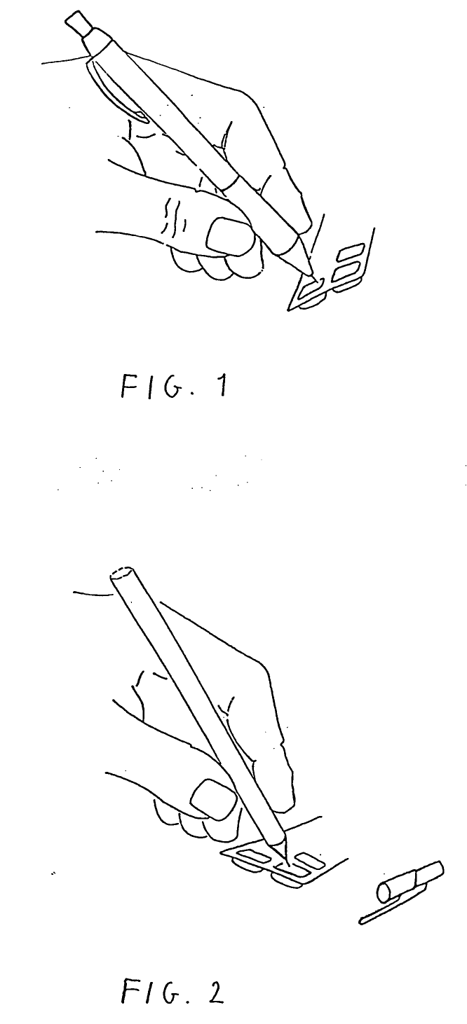

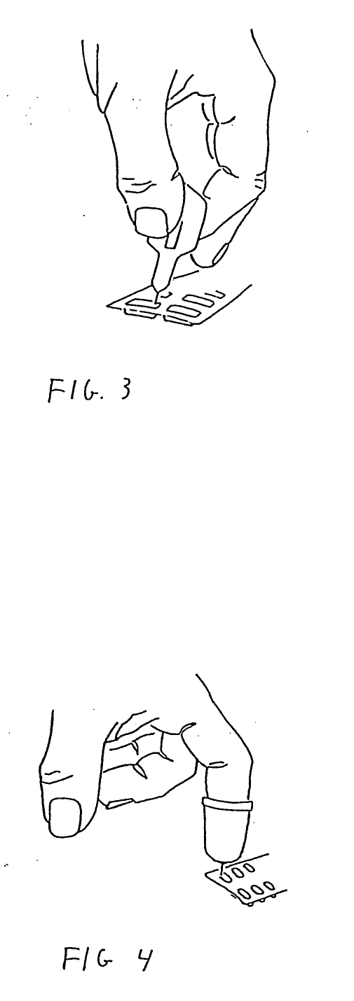

In the FIGS. 1-4 different embodiments of the resent invention are disclosed.

### DETAILED DESCRIPTION OF THE INVENTION

According to the invention the cutter is having suitable transverse dimension and form of cross section at its position of the intended cutting, making it suitable to serve its purpose.

The term “suitable transverse dimension and form of cross section” in the present description intended to mean that the dimension and the shape of the cross section of the cutter is suited to easily be able to cut or tear foils of the type used in blister packs. The person skilled in the art will by simple routine experiment be able to determine if a given transverse dimension is having a suitable transverse dimension and form of the cross section according to the invention.

The term “at the position of the intended cutting” with respect of the cutter according to the present invention is intended to mean the actual position of the cutter where it is in contact with the foil during the cutting. The position of the intended cutting is usually located at the tip of the cutter, such as within 5 mm from the tip of the cutter, preferably within 3 mm from the tip of the cutter.

The transverse dimension of the cutter at the position of the intended cut is preferably less than about 4 mm, more preferred in the range of 0.01 to 4 mm, more preferred in the range of 0.01 to 3 mm, even more preferred in the range of 0.01 to 2 mm and most preferred approximately 0.5 mm.

According to the invention the cutter is formed having a suitable transverse dimension and form of cross section at the position of intended cutting to allow the cutter to be able to cut in practically all directions.

This may be effected by designing the cross section of the cutter without any distinct edge that may improve the cutting in one direction but impair the cutting in other directions.

Examples of suitable forms of the cross section of the cutter according to the invention are: circular, elliptical, polygonal such as triangular, squared or hexagonal, star shaped, rectangular and possible combinations thereof, where a circular or elliptical cross section is preferred. The edges of a polygonal shaped cutter may be sharpned or blunted.

It is preferred that the cutter is formed as an essential round rod.

The term “essential round” in connection with the rod of the cutter is intended to mean that the ratio of the longest transverse dimension to the shortest transverse dimension of the cross section is less that 3, preferably less that 2 and most preferred less that 1.5.

The diameter of the rod of the cutter is intended to mean the largest transverse dimension of the rod at approximately the position of the intended cutting.

The diameter of the cutter determines its cutting properties; a thin rod cuts better that a thicker. Therefore it is preferred to use a thin rod. On the other hand a thin rod will have less mechanical strength, which may lead to shorter lifetime of a devise having a thin rod compared to a thicker. Thus the person skilled in the art will appreciate that the thickness of the rod is selected taking proper considerations to the cutting properties of the rod and the mechanical strength.

Alternatively the cutter may be designed, as a small knife where the blade is so slim that the alteration of direction of the cut can be effected easily by the movement of the handle with use of a minimal force. The small knife may also be mounted on the handle in a way that secures an essentially free rotation around an axis perpendicular to the plane of the foil during operation in order to avoid that the device has a preferred direction of cutting.

The cutter may be made of any material having the desired mechanical strength. Typical the cutter is made of a metal e.g. iron or steel, where steel is a preferred material. Thus a cutter made of a material having a high mechanical strength such as steel may be thinner than a cutter made of a material made of a material having a smaller mechanical strength.

The cutter may be provided with a point in order to facilitate the penetration of the foil.

In a preferred embodiment the cutter has a shape of a rod having a diameter of approximately 0.5 mm.

In another preferred embodiment the cutter has a shape of a rod having a diameter of approximately 0.5 mm further provided with a point.

In one embodiment the cutter is shaped as a shaft having in one end a small point with a smaller diameter than the shaft where the point has a length of 1-2 mm. This design of the cutter secures a high strength simultaneously with outstanding cutting properties.

The device may be provided with means for protection of the cutter during transport, storage and handling of the device in order to avoid unintended cuts.

Examples of means for protection are a protective hood for the cutter, or a cutter arranged to be movable and capable of being located in at least an advanced position and a rejected position where an actuator further is provided in order to switch between these positions.

The term “advanced position” in relation the cutter according to the latter embodiment is intended to mean that the cutter is projecting out of the handle so that it is free and able to cut the foil of the blister pack. The term “rejected position” means that the cutter is drawn into the handle so that the device can be handled and transported without risk for unintended cuts by the cutter. The at least two positions of the cutter in the device according to this embodiment secures that the device on one hand can be transported and stored without risk for unintended cuts in surrounding materials, and at the other time that the cutter can be advanced and in position for use when needed. The actuator is provided in order to be able to switch between the at least two positions for the needle. The positioning mechanism for the invention according to the invention may be any mechanism known per se e.g. from the area of writing instruments.

The handle may serve different purposes in the device according to the invention. First it provides a good grip for the user, which secures that the device, can be easily used with precision. Second the handle provides a cover for the positioning and for the cutter in rejected position if the devise is equipped with such. The handle may be formed in any shape that fulfils these purposes.

Examples, of designs of the device according to the invention are shown in FIG. 1-4.

A preferred shape for the handle according to the invention is the shape of a pen.

Another preferred shape for the handle is a shape that is designed to facilitate use by elderly people or in particular patients suffering from rheumatic diseases.

In use the cutter of the devise penetrates the foil of a blister pack, and the devise is moved completely or partly around along the circumference of the blister. If the devise is moved completely around the circumference of the blister the foil that covered the pill will be released and fall into the blister, if the devise is only moved partially around the circumference the foil that covered the pill will be connected to the blister pack at on edge of the blister. After the foil has been cut the blister pack can be tilted or turned around and the pill will fall out of the blister. In this way the pill can easily be put into a receiving device such as a pill glass or into the hand of the user.

Even though the invention in this description has been described mainly for use with blister packs containing medicaments, the person skilled in the art will appreciate that the device also may be used in any instance where a foil or a cutable wrapping or tape has to be removed in order to open pack or a container.

In this connection “cutable wrapping or tape” is intended to mean any such wrapping or tape that is commonly used within packaging. The skilled person may easily using routine experiments determine is a given wrapping or tape is cutable.

### EXAMPLE

A device according to the figure was made by replacement of the ink cartridge from a pen with a cutter made of a needle having a thickness of approximately 0.5 mm.

Using this device several blister packs containing pills were easily opened and the pills released. Next the blister packs were tilted and the medicament fell out of the blister pack into the hand of the user or into a pill glass as desired.

1. Use of a device comprising a handle and a cutter having a suitable transverse dimension and form of cross section at the position of the intended cutting, making it suitable for cutting the foil of the type used in blister packs for opening blister packs without annular depressions around the blisters and a foil serving as a lid, or for cutting a foil or wrapping used for packaging.

2. Use according to claim 1, wherein the transverse dimension of the cutter at the position of the intended cutting is less than 4 mm.

3. Use according to claim 2, wherein the transverse dimension of the cutter at the position of the intended cutting is in the range of 0.01 to 2 mm.

4. Use according to claim 1, wherein the cutter is. provided with a point.

5. Use according to claim 1, where the handle is formed as a shaft of a pen.

6. Use according to claim 1, wherein the transverse section at the position of the intended cutting has a shape selected from: circular, elliptical, polygonal such as triangular, squared or hexagonal, star shaped, rectangular and possible combinations thereof.

7. Use according to claim 1, wherein the device further comprises means for protection of the cutter.

8. Use according to claim 7, wherein the device comprises a retractable cutter that may be positioned in at least an advanced position and a retracted position and a actuator for changing position of the cutter between said positions.

9. Use according to claim 1, where the handle is formed in a shape that facilitates the grip of a patient suffering of a rheumatic disease.

10. Device for opening blister packs without annular depressions around the blisters and a foil serving as a lid, comprising a handle and a cutter having a suitable transverse dimension and form of cross section at the position of the intended cutting, making it suitable for cutting the foil of the type used in blister packs or for cutting a foil or wrapping used for packaging.

11. Device according to claim 10, wherein the transverse dimension of the cutter at the position of the intended cutting is less than 4 mm.

12. Device according to claim 11, wherein the transverse dimension of the cutter at the position of the intended cutting is in the range of 0.01 to 2 mm.

13. Device according to claim 10, wherein the cutter is provided with a point.

14. Device according to claim 10, wherein the handle is formed as a shaft of a pen.

15. Device according to claim 10, wherein the transverse section at the position of the intended cutting has a shape selected from: circular, elliptical, polygonal such as triangular, squared or hexagonal, star shaped, rectangular and possible combinations thereof.

16. Device according to claim 10, further comprising means for protection of the cutter.

17. Device according to claim 16, comprising a retractable cutter that may be positioned in at least an advanced position and a retracted position and a actuator for changing position of the cutter between said positions.

18. Device according to claim 10, where the handle is formed in a shape that facilitates the grip of a patient disease suffering of a rheumatic disease.
